(19) United States
(12) Patent Application Publication
(10) Pub. No.: US 2025/0131422 A1
(43) Pub. Date: Apr. 24, 2025

(54) Key Exchange Through a Plurality of Non-Trusted Third Parties

(71) Applicant: Sean Harrison Worthington, Chico, CA (US)

(72) Inventor: Sean Harrison Worthington, Chico, CA (US)

(21) Appl. No.: 18/917,632

(22) Filed: Oct. 16, 2024

Related U.S. Application Data
(60) Provisional application No. 63/591,273, filed on Oct. 18, 2023.

(51) Int. Cl. G06Q 20/38; G06Q 20/40

(52) U.S. Cl. CPC G06Q 20/3829; G06Q 20/3823; G06Q 20/4014

(57) ABSTRACT

A method of exchanging cryptographic keys capable of providing users with a keyed encryption mechanism for secure communication that bypasses the vulnerabilities of a commonly known public key. In response to concerns about the ability of quantum computing to trivialize the once secure public key encryption methods, the present invention uses non-trusted third parties to exchange grouped encryption keys instead of reliance on a public key. The present invention operates by generating an ordered set of keys and storing them on common authentication servers which function as intermediaries. The recipient is able to retrieve the keys by leveraging the common servers' authentication. The key is unique to each transaction and no parties other than the sender and receiver will generally be able to access the entirety of the necessary keys to decrypt the underlying information.

### FIELD OF THE INVENTION

The present invention relates generally to a key exchange through a plurality of non-trusted third parties. More specifically, the present invention is a system of exchanging cryptographic keys.

### BACKGROUND OF THE INVENTION

Public key encryption is a common method used for encrypting or signing data with multiple different keys where one of the keys is public and is readily available for anyone to use. The other key or keys are private keys that can be utilized to decrypt the data encrypted with the public key. Unfortunately, with improvements in technology and improvements in quantum computers the public key encryption can theoretically be decrypted and cracked without an individual needing the private key. This provides a big issue for companies and individuals relying on public key encryption through SSL/TLS protocols such as what is commonly used by banks. As quantum computers utilize Shor's algorithm, new key exchange algorithms are needed to protect communications between machines.

An objective of the present invention is to provide users with a system, to help eliminate the easy decryption of public key encryption by quantum computers. The present invention intends to provide users with a system that allows people who do not share an encryption key to exchange encryption keys so that they can communicate without being spied on. In order to accomplish that, a preferred embodiment of the present invention comprises a generation stage, a sending stage, and a compilation stage. Thus, the present invention is a system of exchanging cryptographic keys that prevents quantum computers from utilizing algorithms to crack public encryption keys to read sent and received messages.

### SUMMARY OF THE INVENTION

The present invention is a system for a key exchange through a plurality of non-trusted third parties. The present invention seeks to provide users with a system that does not require any collaboration or communication between servers or third parties. In order to accomplish this the present invention comprises a generation stage that creates a key and divides the key into multiple parts. Further, the sending stage sends the parts of the key to various 3^{rd} parties. Additionally, the compilation stage receives the key parts from various 3^{rd} parties and combines the key parts to communicate with the original sender. Thus, the present invention is a system of exchanging cryptographic keys that prevents quantum computers from utilizing algorithms to crack public encryption keys to read sent and received messages.

### BRIEF DESCRIPTION OF THE DRAWINGS

FIG. 1 is a flow chart diagram of the present invention.

FIG. 2 is a flow chart diagram of the present invention.

FIG. 3 is a flow chart diagram of the present invention.

FIG. 4 is a flow chart diagram of the present invention.

FIG. 5 is an illustration of the present invention.

### DETAIL DESCRIPTIONS OF THE INVENTION

All illustrations of the drawings are for the purpose of describing selected versions of the present invention and are not intended to limit the scope of the present invention.

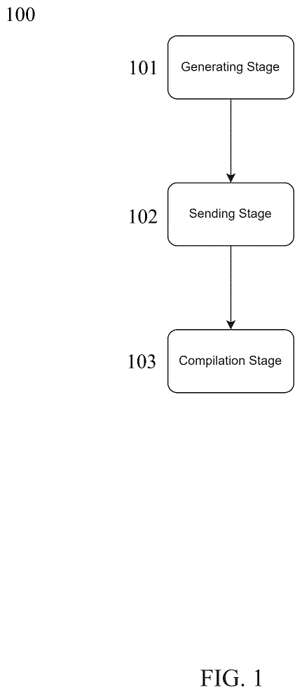

FIG. 1 illustrates the three distinct stages of the present invention (100). An objective of the present invention is to provide users with a system that does not utilize public key encryption making it safe from quantum computer key cracking. The present invention intends to provide users with a system that does not require any collaboration or communication through servers or 3^{rd} parties holding the key parts. To accomplish this the present invention comprises a generation stage (101), a sending stage (102), and a compilation stage (103). Many of these components allow for the key exchange system to not use multi-party computation or any type of computation. The three stages all execute in sequential order. The steps within the generation stage provide a way for the present system to execute without any unwanted 3^{rd} party interfering with the communication. Thus, the present invention is a system of exchanging cryptographic keys that prevents quantum computers from utilizing algorithms to crack public encryption keys to read sent and received messages.

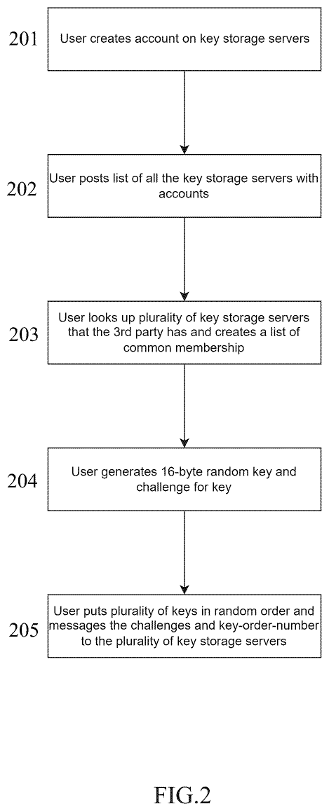

FIG. 2 is a flow-chart charting the generation stage of the method for the present invention (200). The generation stage provides a starting point for keys for encrypted communication to be publicly exchanged by two parties. The generation stage allows a user to produce the necessary components to communicate with another party without unwanted 3^{rd} party interference. In its preferred embodiment the generation stage begins by having the users create accounts on independent servers that will perform the key storage (201). The plurality of accounts is located on the plurality of key storage servers allowing each user to register, becoming a member and being provided with a User ID and password. In some embodiments, the plurality of accounts can be created using a digital currency. Next the user will post a list of all the key storage servers that they have created accounts on (202). The plurality of key servers are independent machines that run the same protocol with a user table that stores usernames and passwords corresponding to each account created by the user. The plurality of key storage servers is capable of sending and receiving various commands to send and receive a plurality of keys or part of the plurality of keys. The list of all the key storage servers is public information obtainable by various parties. The key storage servers are located all over the world in different jurisdictions that are run by independent server administrators that do not need to communicate with each other but simply run the same protocol. The user then looks up all the plurality of key storage servers that the receiving party has, and a list of common membership is created (203). The user then generates a key that is a 16-byte random number (204). In an alternative embodiment the size of the key can range through a variety of any numbers and is not limited to just 16-bytes. A challenge, which is another random number, is then created and this process is repeated for all the key storage servers that the user and the receiving party share membership (204). Further, the plurality of keys created by the user is then placed in a random order and the plurality of keys, plurality of challenges, and key-order-number are then packaged into a plurality of messages, ready to be sent to the plurality key storage servers (205). It should be further noted that the generated key can be created in various random ways while still staying within the scope of the present invention.

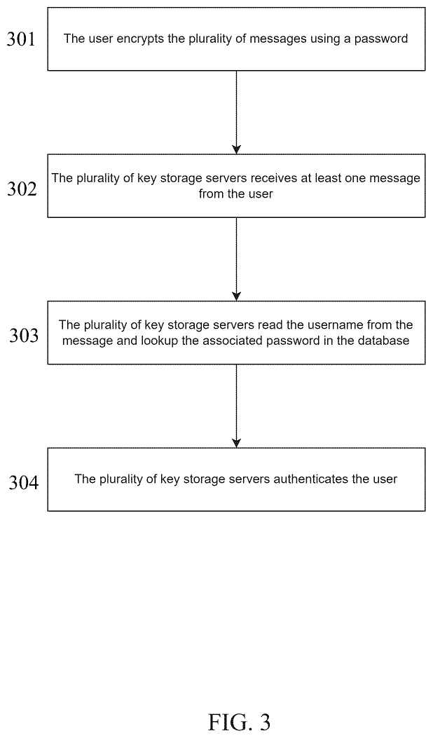

Once the generation stage is complete the sending stage is executed (300), shown in FIG. 3. In its preferred embodiment once the plurality of keys, the plurality of challenges and key-order-number are packaged they are then sent to the plurality of key storage servers. The user then encrypts the messages using a password for each of the plurality of keys and an encryption key (301). Although the plurality of messages is encrypted the username stays unencrypted and each of the plurality of keys is sent to the plurality of servers that are common between the user and the receiving party (302). Each of the plurality of key storage servers receives at least one message from the user where the username is then read by the server notifying the server that the message is from the user (303). Throughout this the message stays encrypted. Each of the key storage servers then searches for the user's password from a database and uses the password to decrypt the message from the user, where the user is then authenticated at this point (304).

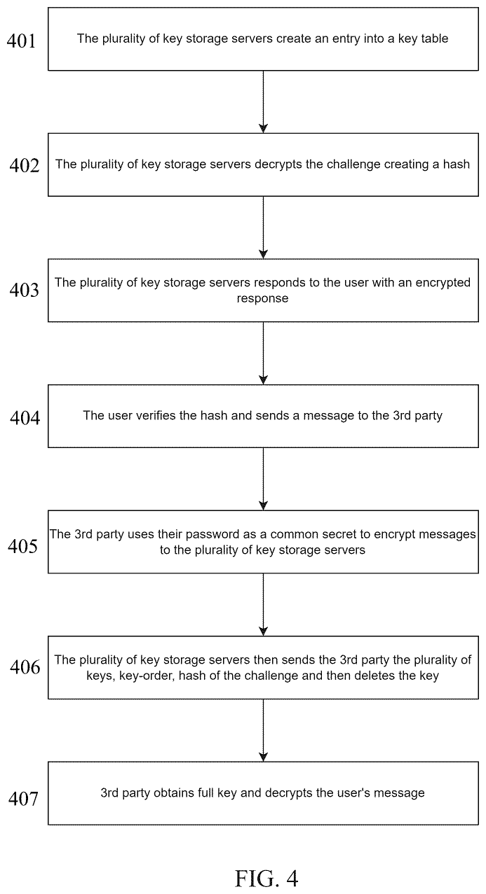

FIG. 4 maps the compilation stage, which is then executed once the sending stage is complete (400). In its preferred embodiment, the compilation stage begins with each of the key storage servers creating an entry into a key table recording who a key is from (the user), who the key is for (the receiving party), what the key is and what the key's order-number is (401). Next, each of the key storage servers decrypts the corresponding challenge and creates a hash (402). This design allows each of the key storage servers to respond to the user with an encrypted response that includes the hash of the challenge and a success status (403). Further, the user then verifies the hash is from the desired 3^{rd} party server and sends a message to the receiving party, indicating where the receiving party can obtain the decryption key with the body of the message staying encrypted (404). The receiving party then utilizes a corresponding password as a common secret to encrypt messages to the plurality of key storage servers with the plurality of messages asking for keys from the user (405). The request from the receiving party also includes a challenge to ensure that the receiving party can mutually authenticate the plurality of key storage servers. Furthermore, the plurality of key storage servers sends the plurality of keys, the key-order-number, and the hash of each of the challenges to the receiving party followed by deletion of the keys and their related information (406). Immediately after the key information is deleted from the plurality of key storage servers, the receiving party is the only party left with the key to decrypt messages from the user. Once the key is received, the receiving party may fully decrypt the message (407).

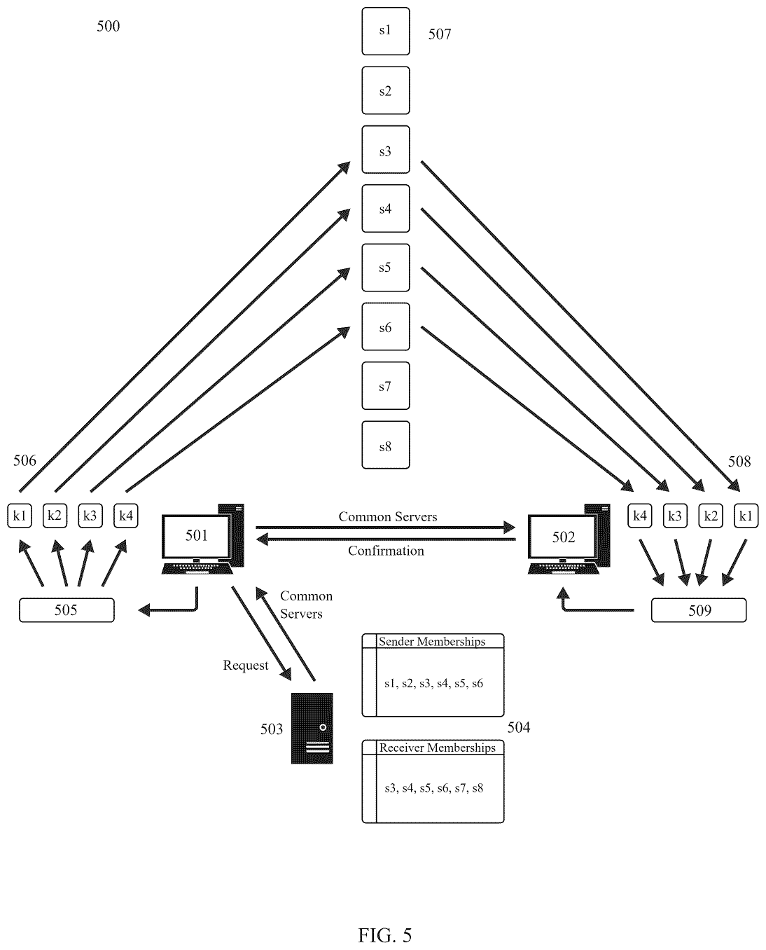

FIG. 5 provides an example visualization of all the stages in concert (500), using eight eligible key servers. Alternate embodiments allow the number of servers and memberships required to scale upward as desired. The sender (501) requests the common key server memberships with the recipient (502) from a public list of server memberships (503). Both the sender's and receiver's memberships are kept in a public list (504). The sender (501) then generates a key (505) that can be broken down as a number of smaller, partial keys corresponding to the number of key servers in common (506). Those smaller keys are stored on the common servers from the collection of all relevant servers (507). The sender (501) then informs the recipient (502) of the common servers to which the partial keys have been sent. The recipient (502) can authenticate with those servers and receive the keys, including their correct ordering (508). The recipient (502) then compiles the partial keys into a fully formed key (509). Once the recipient (502) sends confirmation to the sender (501), encrypted messages may be exchanged and decrypted using the shared fully private key.

With all the steps working in tandem with each other it can be seen that the present invention is a system of exchanging cryptographic keys that prevents quantum computers from utilizing algorithms to crack public encryption keys to read sent and received messages.

Although the invention has been explained in relation to its preferred embodiment, it is to be understood that many other possible modifications and variations can be made without departing from the spirit and scope of the invention.

1. A networked method for exchanging encrypted data without a public key, the method comprising:
providing a sender, comprising a computing device;
providing a receiver, comprising a computing device;
providing three or more independent key servers, each comprising membership authentication software, an encryption protocol, and a non-transitory storage medium;
registering the sender with a separate member account on two or more of the key servers;
registering the receiver with a separate member account on two or more of the key servers;
the sender requesting a list of key servers with which the receiver has registered accounts;
the sender retrieving a list of key servers with which the receiver has registered accounts;
the sender generating an ordered key corresponding to the number of key servers on which the sender and receiver have registered accounts in common;
the sender generating a challenge paired with each key generated;
the sender randomly assigning a key and paired challenge out of order to each key server in common;
the sender encrypting the key-challenge pairs and ordering information into packages corresponding to the assigned key servers, using the encryption protocol employed by the key servers;
sending the packages to the assigned key servers and storing them in association with the sender's account;
each assigned key server authenticating the sender's account;
each assigned key server decrypting the stored package;
each assigned key server recording the sender and receiver's identifying information;
each assigned key server recording the key and its ordering information from the decrypted package;
each assigned key server creating a hash for the key using the challenge from the decrypted package;
each assigned key server encrypting and delivering a message comprising the hash of the challenge and status information to the sender;
the sender verifying the hash;
the sender delivering a list of assigned key servers through which the encryption keys may be obtained and the challenge password;
the receiver requesting the keys from the assigned key servers;
the assigned key servers each authenticating the receiver's accounts and challenge password;
the assigned key servers transmitting the stored key and ordering information to the receiver;
the assigned key servers deleting their records of the stored keys, ordering information, and challenges;
the receiver compiling the received keys in ordered form;
the receiver confirming the encryption key compilation with the sender; and
the sender and receiver exchanging one or more messages encrypted using the compiled keys.

2. The method of claim 1, wherein the membership authentication software is associated with a digital currency.

3. The method of claim 1, wherein the ordered keys generated are each 16-byte random numbers.

4. The method of claim 3, wherein the challenges paired with the ordered keys are random numbers.

5. A networked method for exchanging encrypted data without a public key, the method comprising:
providing a sender, comprising a computing device;
providing a receiver, comprising a computing device;
providing three or more independent key servers, each comprising membership authentication software, an encryption protocol, and a non-transitory storage medium;
registering the sender with a separate member account on two or more of the key servers;
registering the receiver with a separate member account on two or more of the key servers;
the sender requesting a list of key servers with which the receiver has registered accounts;
the sender retrieving a list of key servers with which the receiver has registered accounts;
the sender generating an ordered key corresponding to the number of key servers on which the sender and receiver have registered accounts in common;
the sender encrypting a message for the receiver utilizing the ordered keys;
the sender generating a challenge paired with each key generated;
the sender randomly assigning a key and paired challenge out of order to each key server in common;
the sender encrypting the key-challenge pairs and ordering information into packages corresponding to the assigned key servers, using the encryption protocol employed by the key servers;
sending the packages to the assigned key servers and storing them in association with the sender's account;
each assigned key server authenticating the sender's account;
each assigned key server decrypting the stored package;
each assigned key server recording the sender and receiver's identifying information;
each assigned key server recording the key and its ordering information from the decrypted package;
each assigned key server creating a hash for the key using the challenge from the decrypted package;
each assigned key server encrypting and delivering a message comprising the hash of the challenge and status information to the sender;
the sender verifying the hash;
the sender delivering the encrypted message to the receiver and including information indicating the assigned key servers through which the encryption keys may be obtained and the challenge password;
the receiver requesting the keys from the assigned key servers;
the assigned key servers each authenticating the receiver's accounts and challenge password;
the assigned key servers transmitting the stored key and ordering information to the receiver;
the assigned key servers deleting their records of the stored keys, ordering information, and challenges;
the receiver compiling the received keys in ordered form; and
the receiver decrypting the encrypted message using the compiled keys.

6. The method of claim 5, wherein the membership authentication software is associated with a digital currency.

7. The method of claim 5, wherein the ordered keys generated are each 16-byte random numbers.

8. The method of claim 7, wherein the challenges paired with the ordered keys are random numbers

9. A system for exchanging encrypted data without a public key, the system comprising:
a sending device, comprising a computer;
a receiving device, comprising a computer;
three or more independent key servers, each comprising membership authentication software, an encryption protocol, and a non-transitory storage medium;
wherein:
the sending device registers with a separate member account on two or more of the key servers;
the receiving device registers with a separate member account on two or more of the key servers;
the sending device requests a list of key servers with which the receiving device has registered accounts;
the sending device retrieves a list of key servers with which the receiving device has registered accounts;
the sending device generates an ordered key corresponding to the number of key servers on which the sending device and receiving device have registered accounts in common;
the sending device encrypts a message for the receiving device utilizing the ordered keys;
the sending device generates a challenge paired with each key generated;
the sending device randomly assigns a key and paired challenge out of order to each key server in common;
the sending device encrypting the key-challenge pairs and ordering information into packages corresponding to the assigned key servers, using the encryption protocol employed by the key servers;
the sending device sends the packages to the assigned key servers and storing them in association with the sending device's account;
each assigned key server authenticates the sending device's account;
each assigned key server decrypts the stored package;
each assigned key server records the sending device's and receiving device's identifying information;
each assigned key server records the key and its ordering information from the decrypted package;
each assigned key server creates a hash for the key using the challenge from the decrypted package;
each assigned key server encrypts and delivers a message comprising the hash of the challenge and status information to the sender;
the sending device verifies the hash;
the sending device delivers the encrypted message to the receiver and including information indicating the assigned key servers through which the encryption keys may be obtained and the challenge password;
the receiving device requesting the keys from the assigned key servers;
the assigned key servers each authenticate the receiving device's accounts and challenge password;
the assigned key servers transmitting the stored key and ordering information to the receiving device;
the assigned key servers deleting their records of the stored keys, ordering information, and challenges;
the receiving device compiling the received keys in ordered form; and
the receiving device decrypting the encrypted message using the compiled keys.

10. The system of claim 9, wherein the membership authentication software is associated with a digital currency.

11. The system of claim 9, wherein the ordered keys generated are each 16-byte random numbers.

12. The system of claim 11, wherein the challenges paired with the ordered keys are random numbers.
